(19) United States
(12) Patent Application Publication
(10) Pub. No.: US 2004/0176987 A1
(43) Pub. Date: Sep. 9, 2004

(54) Method of promoting pet care and kit therefor

(75) Inventors: Jason R. Dial, Cincinnati, OH (US); Nathan Daniel Estruth, Cincinnati, OH (US); Margaret Sue Adriatico, Wyoming, OH (US); Paul Anthony Zaffiro, Middletown, OH (US); Jack Lee Stephens, Anaheim, CA (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/378,396

(22) Filed: Mar. 3, 2003

(51) Int. Cl. G06F 17/60; A01K 29/00

(52) U.S. Cl. 705/4; 119/174

(57) ABSTRACT

A method of promoting pet care, by providing an insurance policy for the pet. Typically the insurance policy is for the health of the pet. A kit is provided to the caretaker of the pet. The kit contains a policy which provides a variable period of insurance care for the pet. At least some portion of the variable period of the insurance care is paid for by a third party. Typically, the third party seeks to promote its products in concert with the insurance to the caretaker. The caretaker may purchase future variable periods of the insurance policy or other products, if any, provided in the kit. Other products included in the kit may comprise food/medicine judged to be beneficial to the health of the pet, a pet tracking system, and/or a geofencing system.

### FIELD OF INVENTION

This invention relates to pet care and, more particularly, to a trilateral partnership among a provider of insurance for pets, a caretaker of the pet, and a sponsor of pet care products.

### BACKGROUND OF THE INVENTION

Pets are a routine and ordinary part of everyday life. It is estimated that at least sixty percent of U.S. households have one or more pets, including dogs, cats, fish, birds, snakes, lizards, horses, hamsters, other rodents, other reptiles, etc. Many of these pets, particularly horses, dogs and cats require routine veterinary medical treatment. Exemplary veterinary treatments of animal patients include, but are not limited to, physical examinations, fecal testing, deworming, microchip identification, FeLV/FIV testing of cats, heartworm testing and medication, spaying/neutering, teeth cleaning, vaccinations, flea control, various health screenings, including blood analyses, urine analyses, EKG, other major medical needs, and miscellaneous office visits.

The cost of such treatments can be expensive. The caretaker may not be able to afford preventive medicine, or the proper care for the pet when it is ill or injured. This inability may lead to unnecessary suffering or poorer health of the pet. Accordingly, various veterinary pet care insurance companies and agencies utilizing the licenses of traditional insurance companies have sprung up to fill the void.

Insurance companies which provide for veterinary care take different approaches to how treatment of the animal is covered. For example, Veterinary Pet Insurance (www.petinsurance.com) is licensed and operated to provide health insurance for pets. Major medical coverage is available in amounts up to $14,000 per year. Annual benefit allowances for different wellness procedures currently range from $5.00 for microchip identification to $65.00 for comprehensive health screening. The ShelterCare Pet Insurance Program, likewise, currently offers up to $500 per incident for various treatments of the patients, ranging from ear infections and removal of ingested foreign bodies to fractures and motor vehicle accidents after a $50 deductible.

Yet another approach is found by Cheapest Pet Insurance U.K. Cheapest Pet Insurance U.K. simply offers to save on pet insurance costs. Many other approaches to pet care insurance are also available. Pet Assure (www.petassure.com) advertises itself as a pet insurance alternative, simply providing savings of 25% to 30% on veterinary care, pet services, and pet supplies through participating veterinarians.

For example, Veterinary Pet Insurance has provided a pet health insurance policy to pet adoption agencies. One variable period of the insurance policy was paid for by a veterinarian. The insurance policy could be activated by the caretaker upon adoption of the pet. However, it was found this program had a relatively low activation rate, and the loyalty to the veterinarian who paid the variable period was also low.

Caretakers of the pets include, but are not limited to, the pets' owners, kennels, pet owner's societies, breeders, shelters, pet stores, veterinarians, temporary custodians of the pets, such as neighbors/family members, and pet adoption agencies. The caretaker of the pet may not always be aware of the best method of promoting the health of the pet. By promoting the health of the pet, not only can the pet live more comfortably, the pet will potentially present a lower risk to the insurer. The lower risk may result in a concomitant decrease in the insurance premiums.

Accordingly, there exists a need in the art for a way to promote pet health care. Further, there exists a need for ways to provide affordable insurance and to inform and educate caretakers about the value of pet insurance for the pet. Finally, there exists a need to tie together the intertwined interests of pet health care and educating the caretaker of the pet about the proper care of the pet.

### SUMMARY OF THE INVENTION

The invention comprises a method of and kit for promoting pet care. The pet care kit is provided and presented to the caretaker of the pet. The pet care kit comprises an insurance policy, an offer to purchase an insurance policy or an application for an insurance policy. The insurance policy is sponsored by a sponsor. The sponsor subsidizes the premium for at least one variable period of the pet care insurance policy so that the pet has a period of coverage under the policy. One or more additional items may be provided to the caretaker in the kit as well. The additional item is preferably related to the health and care of the pet. The insurance policy may provide health care coverage or life insurance coverage for the pet.

If additional items are provided in the kit, preferably the items comprise food intended to be fed to the pet. Upon demonstration of the caretaker feeding the food to the pet, the caretaker (or other person responsible for paying the premium for the pet's insurance policy) may receive a reduction in the premiums.

If desired, a promotion may be provided to induce the caretaker of the pet to purchase a predetermined pet food. The predetermined pet food may be judged to provide health benefits to the pet and thereby reduce the likelihood that the pet would need care under the insurance policy and allow the pet to be healthier for day-to-day activities and enjoyment. A method may be provided to monitor compliance with the promotion. For example, compliance may be monitored through purchases of the predetermined pet food. Compliance may also be monitored and/or demonstrated through UPC bar codes/coupon redemption, direct delivery of the food to the caretaker of the pet, loyalty card programs, etc.

All documents cited are, in relevant part, incorporated herein by reference; the citation of any document is not to be construed as an admission that it is prior art with respect to the present invention.

### DETAILED DESCRIPTION OF THE INVENTION

The invention comprises a method of promoting pet care. The method includes providing an insurance policy for the pet. The insurance policy may be actually or constructively provided. By actually providing the insurance policy, a valid or validatable policy is presented to the caretaker. By constructively providing the insurance policy to the caretaker, an offer to immediately or later purchase the insurance policy, an application for an insurance policy or an offer to receive an application, is provided to the user. Providing the insurance policy as simply an offer to purchase provides the benefit that in most states the offeror need not be a licensed insurance agent. Thus, constructively providing the insurance policy in the form of an offer to purchase such policy, and presenting the constructively provided insurance policy to a caretaker, may provide convenience and flexibility not available by actually providing the insurance policy.

The insurance policy is presented to the caretaker of the pet in a kit. The kit contains at least one additional item designed to or intended to maintain or improve the health of the pet. The method may also include the use of the kit by a caretaker.

While it is understood that present invention is useful for domesticated pets, the invention is not so limited. The invention may be used for livestock, endangered species, zoo animals, migratory animals, laboratory animals, animals raised or bred for food or other purposes, etc., all of which are collectively referred to hereunder as “pets.”

The pet care kit has a sponsor. The sponsor of the pet care kit is the entity or individual who makes the pet care kit available to the caretaker or to a third party who provides the kit directly to the caretaker. The sponsor of the pet care kit may manufacture, market, promote, or otherwise provide one or more items in the pet care kit. Alternatively, the sponsor may assemble one or more items in the pet care kit from one or more vendors. The sponsor of the pet care kit may or may not receive direct or indirect benefit by providing the pet care kit to the caretaker.

The pet care kit includes one or more components which are helpful to the maintenance, care, feeding, playtime, recreation, health, or general well-being of the pet. For example, the kit may include food intended to be fed to the pet, vitamins, medicine, dietary supplements, toys for the pet, bedding for the pet, blankets, garments intended to be worn by the pet, leashes, collars, dishes, brushes, literature comprising information about care of the pet, information about food for the pet, product discount coupons such as are redeemable for food or other pet care products, a pet tracking device, a pet care insurance policy, etc.

The pet care insurance policy covers care of the pet, as described above. It is not necessary that the pet care insurance policy be limited to the aforementioned formats but instead may comprise any method of providing for the care, general well-being, preventive maintenance, or any other matter relating to or affecting the health, well-being, and/or happiness of the pet. Of course, the insurance policy may cover all, some, or only limited aspects of the care of the pet. The insurance policy subsists for a set period of time, known as the variable period of the policy. The variable period of the policy may be monthly, quarterly, annually, etc. The variable period of the policy is purchasable upon payment of a premium. Of course, one of skill will recognize that the policy will likely require underwriting approval by the insurer. As used herein, payment of the premium includes both actual tendering of the payment, and a commitment for future payment on behalf of the pet. Thus, payment refers to past, present, and future payments.

Unfortunately, many caretakers do not purchase insurance policies for their pet(s). Oftentimes, the caretakers do not appreciate the benefits of the insurance policy, believe the insurance policy is too expensive, do not understand how the insurance policy operates, are unaware of pet insurance policies, etc. Accordingly, the provider of the insurance policy may wish to provide promotions of the policy. Promotions may include providing a limited number of variable periods of the insurance policy for free or at reduced cost. However, this type of promotional activity is frequently not permitted by regulation. Pet insurance policies are regulated on a state-by-state basis, making it difficult to navigate the various regulations with a consistent promotional format.

According to the present invention, the sponsor subsidizes at least one variable period of pet care insurance and, optionally, multiple variable periods of the insurance. Under the subsidy, the sponsor may pay for all of or only a portion of one or more of the variable periods under consideration. For example, the sponsor may pay the entire premium for one month of the insurance.

As noted above, the insurance may provide limited, partial, or complete coverage of care for the pet under any of the various plans and formats available. This arrangement provides the pet with a predetermined period of coverage under the insurance policy. The period of coverage and the type and format of coverage provided may be extended, expanded, reduced, or modified according to the needs of the pet and wishes of the caretaker.

If desired, one or more additional items may be provided in or ancillary to the pet care kit. It is not necessary that all items in the kit be provided at the same time or in the same location. For example, certain items which are tangible may be presented to the caretaker all at once. Alternatively, items such as coupons, training tips, etc. may be sent via mail, e-mail, etc. Sending these other items separately provides the benefit that such other items may be sent before or after the balance of the kit is provided to the caretaker.

Furthermore, if desired, the entire pet care kit may be virtually provided to the caretaker. By vitually providing the pet care kit, the caretaker may access the kit via the inter-net, intra-net, telephone, mail, package delivery, CD-ROM, etc. Virtual delivery of the pet care kit, as for example via inter-net, provides the benefit that modifications/updates may be made to the kit as needed. For example the insurance policy may require forms/applications to be filled out. The form/application may be filled out on-line, and conveniently e-mailed to the insurance provider. If there are changes to the forms/applications, such changes can be immediately incorporated on-line.

Likewise, virtually offering the pet care insurance kit allows the flexibility to easily incorporate various items in the kit. For example, in the winter the kit may include a coupon redeemable for wearing apparel for the pet. In the summer, the kit may provide a coupon redeemable for a pet carrying cage for travel. Approaching holidays, the kit may provide a coupon redeemable for holiday-themed items usable for the pet, e.g. Halloween food dishes, Christmas reindeer antlers, etc.

Furthermore virtually offering the kit allows items to be bundled in the kit. Certain items may provide an effective promotion when offered together in the kit. For example, offering small quantities of dietary supplements, medicines and/or other pet health enhancing items, together in the kit may be more effective than offering separately offering a larger quantity of each. As styles and fads change, the items offered in the kit may be re-bundled as desired.

This flexibility in timing may be useful for other aspects of the pet's care. For example, the sponsor of the kit may make activation of the insurance policy contingent upon purchase of an item supplied by or sold by that sponsor. Once the caretaker completes the purchase, the variable period of the insurance becomes effective. It will be apparent to one of skill that this system is most effective when the insurance policy and other item(s) in the kit have a common sponsor, although multiple sponsors may be suitable as well.

More particularly, one or more items in the pet care kit may comprise food intended for the pet. The food may be manufactured, marketed, distributed, sold, or otherwise provide a profit, direct or indirect, to the sponsor of the pet care kit. Other items supplied in the pet care kit may be provided by the sponsor or by a third party, each of whom has the opportunity to receive a benefit, promotional or otherwise, by providing its products to the caretaker in this manner.

If the caretaker receives one or more variable periods under the insurance policy, as provided in the kit, the caretaker may elect to extend the insurance policy by purchasing more variable periods. The caretaker receives the benefit of one or more promotional variable periods. The provider of the insurance policy receives the benefit of increasing its customer base. The pet receives the benefit of insurance coverage and, presumably, improved veterinary care. The veterinarian receives the benefit of increasing its patient base and/or the benefit of providing more services to the existing patients. The caretaker receives the benefit of peace of mind in knowing that the pet is well taken care of and comfortable.

If food is provided in the pet care kit, the sponsor or other entity providing the food receives the benefit of distribution of the food product. The caretaker has the opportunity to become accustomed to the food and may continue long-term purchases of that food. This provides a benefit to the sponsor of the kit in that the sponsor may receive long-term profits from sales of such food if there is a common provider. The caretaker receives the benefit of distributing one or more promotional food samples. If the food is of high quality and provides a healthy diet for the pet, the pet receives a health benefit as well.

The kit may be provided to the caretaker at a veterinary facility. This provides the advantage that professional care is available, should the caretaker have questions about proper use of the kit. The veterinarian may also sell food similar to, and even identical to, that provided in the kit. This provides the benefit of a stable diet for the pet and potential revenue for the veterinarian.

If the pet food is judged to provide a health benefit upon feeding to the pet, the provider of the insurance policy may provide a reduction in the premiums for coverage of that pet. It is well known that differences in lifestyle, including smoking, distance traveled to work, etc., all affect the risk level associated with providing insurance to a person and, likewise, affects the premiums. Similarly, the lifestyle of a pet, including its diet, may be influenced or affected by its food. Thus, the caretaker of the pet may seek a reduction in the value of the premiums based upon benefits provided by the food.

The premiums have a set value. The set value is defined as the price of the premium without consideration of extraordinary risk factors which would raise the premium and, further, without considering any extraordinary benefit factors which would reduce the premium. The insurance carrier may provide a reduction in the premiums in response to feeding the pet food to the pet. The first reduction brings the premium to a first reduced value. Another reduction in value brings the premium to a second reduced value, the second reduced value costing less than the first reduced value, etc. This arrangement provides a tiered reduction in the premiums. It has to be recognized that the cost of the premiums may be reduced in a number of ways, each of which is within the scope of the claimed invention. For example, the out-of-pocket costs may be reduced, the length or number of the variable periods may be extended, the level of coverage provided under the policy may be increased, etc. The tiered reduction may be based upon any factor which takes the health, risk, and lifestyle of the pet into consideration.

Of course, the opportunity for fraud or misuse is present. A caretaker or other person paying for insurance premiums could falsely, mistakenly or inaccurately claim that the caretaker has fed the predetermined and proper pet food to the pet when, in fact, this has not taken place. Accordingly, it is necessary that the caretaker demonstrate he/she has acquired the pet food. It is assumed that if the pet food has been acquired by the caretaker, it will be fed to the pet rather than disposed of or resold into a secondary market. In order to demonstrate the pet food was acquired, a coupon or UPC bar code, as is currently known in the art, may be used and redeemed by the caretaker. The coupon may be provided with a bar code or human readable data so that upon redemption it is traceable to a particular caretaker. The coupons may be provided in the pet care kit or otherwise distributed and provided to the caretaker or the caretaker's agent. Upon redemption, the caretaker is credited for having demonstrated acquisition of the pet food and presumably feeding the pet food to the pet.

Alternatively, the food may be delivered directly to the caretaker or to the location at which the pet is being kept. Alternatively, compliance may be tracked through dedicated or general credit/debit card purchases. Alternatively, a loyalty care program may be used, as is currently known in the art to track quantity/frequency of purchases.

Upon feeding the desired pet food to the pet, a tiered insurance premium reduction structure may be provided for the pet. A first reduced value of the premiums may be provided after a set period of time; e.g., one year, of feeding the food to the pet occurs. A second reduced value may be provided after a second period of time, a third reduced value may be provided after a third period of time, etc. The third reduced value is less than the second reduced value which is less than the first reduced value which is less than the set value.

If desired, a dietary supplement may be provided to the caretaker or otherwise provided for feeding to the pet. Preferably, the dietary supplement is provided as part of the pet care kit. The caretaker or other person may recognize a further reduction in premiums to a second reduced value, third reduced value, etc. upon demonstrably acquiring and presumably feeding to the pet the dietary supplement. It is to be recognized that the reduction in premium is based upon the insurance carrier believing that the dietary supplement will reduce the risk of the pet encountering poor health.

Another manner in which the health of the pet may be maintained or improved is by providing a promotion of pet care products. The promotion comprises any marketing effort, advertising campaign, subsidy, etc. intended to induce a caretaker of the pet to purchase or have purchased on the caretaker's behalf the predetermined pet food, vitamins, diet supplements, oral care products, etc. which are beneficial to the health of the pet. The promotion may be in the form of a caretaker loyalty program. The purchases of the caretaker under the promotion can be monitored, as is well known in the art. For example, monitoring may be done by bar code scanning at the checkout, by recording purchases through direct shipments, through directed communication upon proof of purchase back to the supplier of the pet food, etc.

Of course, the pet care insurance policy may have higher premiums if the pet is frequently lost. Being lost increases the risk of the pet being attacked by other animals, hit by traffic, encountering poisonous vegetation, etc. Alternatively, keeping the pet at home or in a confined area and preventing the pet from becoming lost may result in a reduced premium. The aforementioned risks are minimized if the pet is kept in a predetermined area or is quickly found should the pet become lost.

Optionally, a pet tracking system may be provided in the kit. The pet tracking system includes one or more components which allow the caretaker of the pet to find the pet should it become lost, leave the yard or designated area, escape confinement, etc. As used herein, tracking includes both time-based monitoring of the pet's location and a static determination of the pet's location. The tracking system may be provided with or attachable to a collar. The collar may or may not be included in the kit.

The pet tracking system comprises a transceiver. The transceiver receives a location signal, either automatically upon timed intervals or in response to an inquiry from a caretaker or its surrogate. The tracking system determines its location via GPS, triangulation, etc. using means well known in the art. The location may be sent from the tracking system, which is now located remote from the caretaker, to a base station. At the base station, an indicium of the location is read or displayed to the caretaker in human readable form. Alternatively, the location may be transmitted directly to a cell phone, personal digital assistant, computer, etc., all of which directly accessible by the caretaker. In yet another alternative, the pet's location is designated by providing an audible or visual signal so that the pet may be found in situ. Illustrative pet tracking devices may be found in U.S. Pat. No. 5,650,770, issued Jul. 22, 1977 to Schlager, et al.; U.S. Pat. No. 6,121,922, issued Sep. 19, 2000 to Mohan; and U.S. Pat. No. 6,421,001 B, issued Jul. 16, 2002 to Durst, et al.

Accordingly, a reduction in premiums may occur if the caretaker of the pet utilizes a pet tracking system. Therefore, the sponsor of the pet care kit may include a pet tracking system in the kit. If the caretaker of the pet utilizes the tracking system, then a reduction in the premiums may result.

Furthermore, geofencing technology is well known in the art. Geofencing technology includes buried wires which, through RF transmission, stimulate the pet with a warning and/or correction should the pet come too close to the boundary. Geofencing systems for pets are illustrated by U.S. Pat. No. 6,271,757, issued Aug. 7, 2002 to Touchton, et al.; U.S. Pat. No. 6,166,643, issued Dec. 26, 2000 to Janning, et al.; U.S. Pat. No. 6,151,276, issued Nov. 21, 2000 to Peinetti; and U.S. Pat. No. 6,065,427, issued May 23, 2000 to Peinetti. Other geofencing techniques include systems which automatically alert the caretaker or a service which notifies the caretaker should the pet leave the predetermined area.

A further reduction in premiums may be provided if the pet tracking system includes geofencing capability. Again, a tiered premium structure may be present, as described above, wherein the premiums are reduced from a set value to a first reduced value upon use of a tracking system and further reduced to a second reduced value upon use of a unit with geofencing capability.

Another variation in the pet insurance is that the insurance policy may include a life insurance policy instead of or in addition to the health care insurance policy. Upon the death of the pet, the life insurance policy pays a death benefit to the caretaker or holder of the policy. The benefit payment may be used to bury/cremate the pet, purchase a new pet, etc. By knowing that the death of the pet is covered, the caretaker is free to concentrate on other aspects of pet care, and thereby the health of the pet may be promoted.

The pet care kit may be provided to the caretaker directly or indirectly. By directly, it is meant that the pet care kit is given to the caretaker without an intermediate party. By indirectly, it is meant the pet care kit passes through a third party prior to ultimate receipt by the caretaker. The pet care kit may be provided at any convenient facility or in any convenient means, including retail stores, veterinary facilities, kennels, breeders, trade associations, such as the American Kennel Club, etc., pet stores, adoption agencies, etc.

Of course, one of skill will recognize that pet care insurance is a regulated industry. One practicing the methods described and claimed herein will want to maintain compliance with all applicable local, state and federal regulations, to ensure that the insurance policy is properly presented to the caretaker, premiums are properly approved, underwriting properly occurs, all necessary regulatory approvals are in place, etc.

While particular embodimentsof the present invention have been illustrated and described, it would be obvious to those skilled in the art that various other changes and modifications can be made without departing from the spirit and scope of the invention. Any of the aspects of the invention of the present invention found to offer advantages over the state of the art may be used separately or in any suitable combination to achieve some or all of the benefits of the invention disclosed herein.

What is claimed is:

1. A method of promoting pet care, said method comprising the steps of:
(a) providing an insurance policy covering pet care, said policy having periodic variable periods, each variable period being purchasable upon payment of a premium;
(b) providing a pet care kit, said pet care kit comprising said insurance policy and being sponsored by a sponsor, said sponsor subsidizing at least one variable period of said pet care insurance policy, whereby said pet has a period of coverage under said insurance policy; said kit further comprising at least one item usable for the care of said pet and
(c) presenting said kit to a caretaker of said pet.

2. A method according to claim 1 wherein said at least one additional item comprises food for said pet.

3. A method according to claim 2 wherein said variable period of said insurance policy becomes effective upon the purchase of additional food for said pet, said additional food being provided by the sponsor of said kit.

4. A method according to claim 3 wherein said food for said pet and said subsidy for said variable period of said insurance policy are provided by a common sponsor of said kit.

5. A method according to claim 4 wherein said caretaker demonstrably acquires said pet food and further comprising the step of seeking a reduction in said premium based upon the acquisition of said food for said pet.

6. A method according to claim 5 further comprising the step of receiving a first reduction in said premiums for at least one said variable period in response to feeding said food to said pet.

7. A method according to claim 6 further comprising the steps of:
(a) establishing a caretaker loyalty program associated with said pet food; and
(b) providing at least one additional reduction in said premiums to reward said caretaker for participating in said loyalty program.

8. A method according to claim 2 wherein said step of providing said kit to said caretaker is performed at a veterinary facility.

9. A method according to claim 8 wherein said veterinarian sells food for said pet, said food being similar to that contained in said kit.

10. A method of promoting pet health, said method comprising the steps of:
(a) providing an insurance policy covering care for said pet, said policy having at least one periodic variable period purchasable upon payment of a premium, said premium having a set value;
(b) making a predetermined pet food available to a caretaker of the pet;
(c) providing a promotion for said caretaker of the pet to purchase said predetermined pet food;
(d) providing a method to monitor purchases of said food;
(e) monitoring purchases of said pet food by said caretaker; and
(f) reducing said premium below said set value to a first reduced value for said caretaker in response to purchasing said food for said pet.

11. A method according to claim 10 further comprising the step of feeding said pet a dietary supplement and reducing said premium to a second reduced value based upon feeding said dietary supplement to said pet, said second reduced value being less than said first reduced value.

12. A method according to claim 10 further comprising the steps of providing a tiered reduction in said premiums, said tiered reduction in said premiums being based upon the quantity of food purchased by said caretaker.

13. A method according to claim 1, said method comprising the steps of:
(a) providing a pet care kit further comprising a pet tracking system, said pet tracking system being capable of providing an indicium of the location of said pet; and
(b) disposing said pet tracking system on or in the vicinity of said pet, whereby said tracking system is located proximate said pet to provide an indication of the location of said pet.

14. A method according to claim 13, wherein said premium has a set value, and further comprising the step of reducing said set value to a first reduced value upon use of said pet tracking system by said caretaker, said first reduced value being less than said set value.

15. A method according to claim 13, wherein said pet tracking system has geofencing capability, defining a predetermined boundary within which said pet is to be included or excluded, and further comprising the step of reducing said premium to a second reduced value based upon the use of said geofencing capability by said caretaker, second reduced value being less than said first reduced value.

16. A method according to claim 14 wherein said pet tracking system has a periodic variable period purchasable upon payment of a periodic premium, and further comprising the step of subsidizing said periodic variable period of said pet tracking system by a sponsor.

17. A method according to claim 1, said method comprising the step of providing a pet care kit further comprising geofencing capability, said geofencing capability defining a predetermined boundary from which said pet is intended to be included or excluded.

18. A kit for promoting care of a pet, said kit comprising:
items for feeding to a pet and an insurance policy covering said pet, said insurance policy having a variable period purchasable upon payment of a premium, said premium being subsidized by a sponsor.

19. A kit according to claim 18 wherein said insurance policy covers health care of said pet.

20. A kit according to claim 18, wherein said kit comprises medicine for said pet.
